(19) United States
(12) Patent Application Publication
(10) Pub. No.: US 2006/0159934 A1
(43) Pub. Date: Jul. 20, 2006

(54) Substrate with a reduced light-scattering, ultraphobic surface and method for the production of the same

(75) Inventors: Karsten Reihs, Koeln (DE); Angela Duparre, Jena-Kunitz (DE); Gunther Notni, Jena (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: SUNYX SURFACE NANOTECHNOLOGIES GMBH, Koeln (DE)

(21) Appl. No.: 11/376,129

(22) Filed: Mar. 16, 2006

Related U.S. Application Data
(63) Continuation of application No. 10/304,619, filed on Nov. 26, 2002, now abandoned.
Application No. 10/304,619 is a continuation-in-part of application No. PCT/EP01/05942, filed on May 23, 2001.

(30) Foreign Application Priority Data
May 26, 2000 (DE) 100 26 299.6

(51) Int. Cl. B32B 17/06; B32B 9/00

(52) U.S. Cl. 428/432; 428/698; 428/702; 428/336

(57) ABSTRACT

The Invention relates to a substrate with a reduced light-scattering, ultraphobic surface, to a method for the production of said substrate and to the use thereof. The substrate with a reduced light-scattering, ultraphobic surface has a total scatter loss ≦7%, preferably ≦3% and especially ≦1% and a contact angle in relation to water of ≧140°, preferably ≧150°.

This application is a Continuation of U.S. application Ser. No. 10/304,619, filed on Nov. 26, 2002, now pending; which is a Continuation-in-Part of International Application No. PCT/EP01/05942, filed May 23, 2001.

This invention relates to a substrate with a reduced light-scattering, ultraphobic surface, to processes for its production and the use thereof.

Ultraphobic surfaces with reduced light scatter can, for example, be used in any application where sticking water droplets or contamination by dirt or dust particles impair vision, for example, windows or exterior mirrors in cars, architectural windows, camera lenses, eyeglasses.

Consequently, there have been many attempts to make such ultraphobic surfaces available.

For example, EP 476 510 A1 discloses a method for the production of a hydrophobic surface in which a metal oxide film with a perfluorinated silane is applied to a glass surface. However, the surfaces produced with this method have the drawback that the contact angle of a drop on the surface is less than 115°.

Methods for the production of ultraphobic surfaces are known from WO 96/04123. This patent application explains inter alia how to produce synthetic surface structures from elevations and indentations whereby the distance between the elevations is in the range from 5 to 200 μm and the height of the elevations is in the range of from 5 to 100 μm. However, surfaces roughened in this way have the disadvantage that due to their size the structures result in intensive light scattering, causing the objects to appear extremely hazy. This means that such objects cannot be used for optical applications, such as for example, the production of glass for transport vehicles or for buildings.

Also explained in U.S. Pat. No. 5,693,236 are several methods for the production of ultraphobic surfaces in which microneedles of zinc oxide are applied with a binder to a surface and then partially uncovered in a different way (e.g. by means of a plasma treatment). The surface roughened in this way is then coated with a water-repellent chemical. Surfaces structured in this way have contact angles of up to 150°. However, due to the size of the unevenness, here the surface is extremely light-scattering.

A publication by Kazufumi Ogawa, Mamoru Soga, Yusuke Takada and Ichiro Nakayama, Jpn. J. Appl. Phys. 32, Part 2, No. 4B, 614-615 (1993) describes a method for the production of a transparent ultraphobic surface in which a glass plate is roughened with a radio frequency plasma and subsequently coated with a fluorine-containing silane. It is suggested that the glass plate be used for window glass. The contract angle for water is 155°. However, the method described has the disadvantage that the transparency is only 92% and the size of the structures of several 100 nm causes significant haze due to scatter losses. In addition, the roll-off angle for water droplets with a volume of 10 μl is still approximately 35°.

The publications of K. Tadanaga, N. Katata and T. Minami in J. Am. Ceram. Soc. 80 (12), 3213 (1997) and J. Am. Ceram. Soc. 80 (4), 1040 (1997) describe a highly water repellent coating made from aluminium oxide (boehmite) that is covered with a film of the hydrophobic heptadecafluorodecyltrimethoxysilane. A contact angle of 165° was obtained for water. The authors do not give any results of scatter losses. Only the transparency of the films is given as higher than 92% which can still allow for 8% scatter losses and an opaque appearance of the coating. The authors, however, show scanning electron micrographs that display the surface roughness in detail. An unevenness from features up to 200 nm in size is displayed by the micrographs. The cross section of the coating that is given in the disclosure (FIG. 1) reveals a rms-roughness of 80 nm over its length of 1 μm. Calculations of scatter losses with these randomly distributed features in the disclosure yield scatter losses of about 10%. This result is unacceptably high for many applications such as glazing for transportation vehicles or architectural windows were undistorted visibility of objects in far distances from the glazing is required.

In yet another disclosure by K. Tadanaga, K. Kitamuro, A. Matsuda, T. Minami, J. Sol-Gel Sci. Techn. 26, 705 (2003) the authors describe boehmite coatings that are treated with a fluoroalkylsilane that yield a water contact angle larger than 150°. The structure that is displayed in the disclosure is very similar to other boehmite coatings that were published by some of the authors before and consists of a porosity with voids of several 100 nm that are known to yield high light scatter and an opaque appearance.

The publication of Masahi Miwa, Akira Nakajima, Akira Fujishima, Kazuhito Hashimoto, Toshiya Watanabe, Langmuir 16, 5754 (2000) also discloses coatings made from boehmite that are hydrophobized by a fluorinated silane. The contact angles for water are 160°. The structures of the roughness are 100-300 nm high and display lateral dimensions of up to 1 μm. The transparency that was achieved is around 90%. The size of these structures causes high scatter losses that will not permit optical applications such as windows.

In Langmuir 16, 7044 (2000) the authors Akira Nakajima, Kazuhito Hashimoto, Toshiya Watanabe, Kennishi Takai, Goro Yamauchi, Akira Fujishima report highly hydrophobic transparent coatings made from mixtures of titanium oxide and aluminium oxide that are hydrophobized by a thin coating of a fluoroalkylsilane. Contact angles for water of up to 156° were achieved. The scanning electron microscopy micrographs show rough surface structures larger than 100 nm, indicating such large surface structures that cause high scatter losses.

In U.S. Pat. No. 5,800,918 Chartier et al. disclose a multi-layered hydrophobic window glass comprising a substrate made of glass, which is optionally covered, at least in part, by one or more layers and a coating comprising an essentially mineral sublayer and directely bonded thereto a hydrophobic-oleophobic layer. Herein the density of the mineral sublayer is at least 80% of that of its constituent material. The coatings produced in this manner, however, have the drawback that the contact angles of water are not larger than 120°. The roughness was also investigated in this disclosure. The authors report a peak-to-valley roughness of 20 Å, 180 Å, 240 Å, 300 Å, 20 Å for the sublayers 3, 4, 5, 6, and 8 respectively. The data were obtained using a profile measuring device with a tip radius of 5 μ. The height profile was measured over a length of 50 μm. The lateral size of the structures that are characterized in U.S. Pat. No. 5,800,918 is considerably larger than those of the present invention. Here, we use a tip radius smaller than 5 nm and a scan length of 1 μm. A tip with a diameter of 5 μm will not detect such fine roughness structures that are disclosed in the present invention. To a first approximation the tip radius is the lower limit of the spatial dimension of structures that can be measured by a profilometer. This lateral dimension is a factor of 1000 larger in U.S. Pat. No. 5,800,918. Thus, the data reported in U.S. Pat. No. 5,800,918 characterize a completely different lateral regime of roughness structures and can therefore not be compared to those data disclosed here. Moreover the significance of the data in U.S. Pat. No. 5,800,918 to light scatter losses is very limited. For details see C. Ruppe, A. Duparré, Thin Solid Films, 288, 8 (1996) which is cited here as a reference and hence is part of the disclosure. The motivation of roughness determination in U.S. Pat. No. 5,800,918 may more likely be the characterization of the process and its ability to produce fairly dense coatings which is the aim of the invention.

A method for preparing optically transparent and highly hydrophobic silica based films are described in H. M. Chand, Y. Wang, S. J. Limmer, T. P. Chou, K. Takahashi, G. Z. Cao, Thin Solid Films 472, 37 (2005). The authors prepare silica based films by means of sol-gel processing and self assembly of a monolayer of a fluoroalkylsilane. The highest water contact angle was reported as 150°. However, the authors mention that this sample contained silica nanoparticles of 100 nm in diameter and possesses a porosity with size close to the wavelength of light. Such structures cause high scatter losses which is admitted in the disclosure.

Transparent ultraphobic coatings produced from alkoxysilanes by microwave plasma chemical vapour deposition are disclosed in Y. Wu, H. Sugimura, Y. Inoue, O. Takai, Chem. Vap. Deposition 8, 47 (2002). Water contact angle larger than 150° were achieved. However, the roughness of the coating as displayed from scanning electron micrographs in the disclosure reveals structures of at least 100 nm yielding an rms-roughness in this dimension. This coating will therefore consist of too high light scatter losses for optical applications.

It should be mentioned that the optical quality of roughened ultraphobic surfaces that is needed for coatings on windows, for example, can only be adequately achieved by avoiding optical scatter losses. Very often the optical quality of transparent ultraphobic films is demonstrated by a coated substrate that is directly lying on a flat object such as printed paper that is partially covered by the substrate. The letters or symbols of the printed paper are then clearly visible, as much as on neighboured areas without the substrate. Indeed, this test may demonstrate the transparency of the coating very evidently. However, a coating with high optical scatter will give the same result. High optical scatter that is easily produced when surfaces are roughened—such as when ultraphobic coatings are prepared—leads to an opaque appearance of an object seen through the glass only when it is far away from the glass. Only at a larger distance will the object appear distorted and cloudy when observed through a high scatter window. This phenomenon can be easily observed in e.g. opaque plastic covers of paper files or opaque glass covers of picture frames. The glass is made opaque (high scatter) to reduce direct reflection or gloss. As one knows from everyday experience these opaque glass covers display cloudy objects when they are far behind the glass, however, when in the frame the picture that is directly behind the glass appears crisp and undistorted. It is worth to mention that the total scatter loss of such glass covers is typically in the order of 5%.

One particular problem is the fact that the reduction of light scatter losses requires to make a surface flat. On the contrary ultraphobic surfaces require high surface roughness that therefore contradicts low scatter losses. It was therefore believed that extremely hydrophobic surfaces can be transparent though but have to maintain opaque and cannot be processed into low scatter “glossy” surfaces.

Another problem is the fact that surfaces with reduced light scatter which are to be simultaneously ultraphobic may be produced with a wide variety of materials with extremely different surface topographies, as is evident from the examples cited above. In addition, substrates with reduced light scattering and ultraphobic surfaces may also be produced with extremely different types of coating processes. Finally, matters are particularly complicated by the fact that the coating processes must be performed with specific precisely defined process parameters.

Therefore, the object is to provide transparent substrates in which there is no impairment of vision due to haze and non-transparent substances with a high surface gloss whereby the substrates are ultraphobic.

The object is achieved according to the invention by a substrate having a reduced light scattering ultraphobic surface which is characterized in that it has a topography with a root mean square (rms-) roughness determined from an area of 1 μm×1 μm between 1 nm and 50 nm, preferably between 2 nm and 30 nm, more preferably between 3 nm and 25nm, and most preferably between 4 nm and 20 nm and the substrate consists of a hydrophobic, or in particular oleophobic material, or is coated with a hydrophobic or, in particular oleophobic material.

The inventive substrate with a reduced light-scattering, ultraphobic surface has a total scatter loss of ≦3%, preferably ≦1%, more preferably ≦0.5%, most preferably ≦0.2%, and preferably a contact angle in relation to water of at least 140°, preferably at least 150°, and a roll-off angle of ≦20°, preferably ≦10°.

Here, the roll-off angle is understood to mean the angle of inclination of an essentially planar but structured surface relative to the horizontal at which a stationary liquid droplet with a volume of 10 μl is moved due to the force of gravity if the surface is inclined by the roll-off angle.

The substrate consists of a hydrophobic, and/or a oleophobic material, or is coated with a hydrophobic and/or a oleophobic material. For the purposes of the invention, a hydrophobic material is a material having a contact angle of more than 90° for water when processed into a flat, non-structured surface. For the purposes of the invention, an oleophobic material is a material having a contact angle for long-chain n-alkanes, such as n-decane, of more than 90° when processed into a flat, non-structured surface.

For the purposes of the invention, a reduced light-scattering surface designates a surface on which the scatter losses caused by roughness, determined according to the standard ISO/DIS 13696, is ≦3%, preferably ≦1%, more preferably ≦0.5% most preferable ≦0.2%. The measurement is performed at a wavelength of 514 nm and determines the total scatter losses in the forward and backward directions. The precise method is described in the publication by A. Duparré and S. Gliech, Proc. SPIE 3141, 57-64 (1997), which is cited here as a reference and hence is part of the disclosure. Ultraphobic surfaces are characterized by the fact that the contact angle of a drop of a liquid, usually water, lying on the surface is significantly larger than 90° and that the roll-off angle does not exceed 20°. Ultraphobic surfaces with a contact angle of ≧140° and a roll-off angle of ≦20° are very advantageous technically because, for example, they cannot be wetted with water or oil. Dirt particles adhere poorly to these surfaces. The surfaces are highly contamination-resistant because contaminated liquid droplets roll off the surface and do not evaporate on the surface avoiding stain or spots at the surface. The surfaces are also self-cleaning. Here, self-cleaning is understood to mean the ability of the surface to readily relinquish dirt or dust particles adhering to the surface into liquid droplets rolling over the surface.

The rms-roughness of the surface is determined by scanning atomic force microscopy (AFM), a measurement method generally known to the person skilled in the art. For the present purpose a height profile of the surface is recorded in tapping mode using a scan area of 1 μm by 1 μm with a resolution of N=512×512 data points. Details of the measurement technique for the optical applications in this invention can be found in C. Ruppe, A. Duparré, Thin Solid Films, 288, 8 (1996) which is cited here as a reference and hence is part of the disclosure. Si tips with a diameter less than 10 nm are required to perform the measurements. The rms-roughness σ as routinely determined by the software of AFM instruments is defined as:

$$σ = \sqrt{\frac{{\sum }_{i = 1}^{N} {( {Z}_{i} - {Z}_{av} )}^{2}}{N}}$$

where Zᵢ are the heights of the surface profile and Zₐᵥ is the average height.

Preferred is a substrate with abrasion resistance determined by the increase in haze according to test method ASTM D 1003 of ≦10%, preferably ≦5%, after abrasion stress using the Taber Abrasion method according to ISO 3537 with 500 cycles, a weight of 500 g per abrading wheel and CS10F abrading wheels. After treatment with the sand trickling test (“Sandrieseltest”) according to DIN 52348, preferably an increase in haze of ≦15%, preferably ≦10%, more preferably ≦5% takes place. The increase in haze is measured in accordance with ASTM D 1003. To measure haze, the substrate with the surface is irradiated with visible light and the scattered fractions responsible for the haze are determined.

In order, for example, to facilitate its use as windows in cars or in buildings, the surface must preferably simultaneously have preferably good resistance to scratching or abrasion. After exposure to abrasion using the Taber Abrasion method according to ISO 3537 (500 cycles, 500 g per abrading wheel, CS1OF abrading wheels), the maximum increase in haze should preferably be ≦10%, preferably ≦5%. After exposure to scratching in the sand trickling test according to DIN 52348, the increase in haze should preferably be ≦15%, preferably ≦10%, more preferably ≦5%. The increase in haze following either one of the two mechanical abrasion procedures is determined according to ASTM D 1003.

Also preferred is a substrate characterised in that, for a water droplet with a volume of 10 μl, the roll-off angle is ≦20°, preferably ≦10° on the surface.

The ultraphobic surface or its substrate preferably comprises plastic, glass, ceramic material, metal or carbon.

a) Plastics

Particularly suitable for the ultraphobic surface and/or its substrate is a thermosetting or thermoplastic plastic.

The thermosetting plastic is in particular selected from the following series: diallyl phthalate resin, epoxy resin, urea-formaldehyde resin, melamine-formaldehyde resin, melamine-phenolic-formaldehyde resin, phenolic-formaldehyde-resin, polyimide, silicone rubber and unsaturated polyester resin.

The thermoplastic plastic is in particular selected from the series: thermoplastic polyolefin, e.g. polypropylene or polyethylene, polycarbonate, polyester carbonate, polyester (e.g. PBT or PET), polystyrene, styrene copolymer, SAN resin, rubber-containing styrene graft copolymer, e.g. ABS polymer, polyanide, polyurethane, polyphenylene sulphide, polyvinyl chloride or any possible mixtures of said polymers.

In particular suitable as the substrate for the surface according to the invention are the following thermoplastic polymers:

polyolefins, such as polyethylene of high and low density, i.e. densities of 0.91 g/cm³ to 0.97 g/cm³ which may be prepared by known methods, Ullmann (4^{th} Edition) 19, page 167 et seq, Winnacker-Küickler (4^{th} Edition) 6, 353 to 367, Elias and Vohwinkel, Neue Polymere Werkstoffe für die Industrielle Anwendung (New polymeric materials for industrial use), Munich, Hanser 1983.

Also suitable are polypropylenes with molecular weights of 10,000 g/mol to 1,000,000 g/mol which may be prepared by known methods, Ullmann (5^{th} Edition) A10, page 615 et seq, Houben-Weyl E20/2, page 722 et seq, Ullmann (4^{th} Edition) 19, page 195 et seq, Kirk-Othmer (3^{rd} Edition) 16, page 357 et seq.

However, also possible are copolymers of the said olefins or with other α-olefins, such as for example:
Polymers of ethylene with butene, hexane and/or octane EVAs (ethylene-vinyl acetate copolymers), EEAs (ethylene-ethyl acrylate copolymers), EBAs (ethylene-butyl acrylate copolymers), EASs (acrylic acid-ethylene copolymers), EVKs (ethylene-vinyl carbazole copolymers), EPBs (ethylene-propylene block copolymers), EPDMs (ethylene-propylene-diene copolymers), PBs (polybutylenes), PMPs (polymethylpentenes), PIBs (polyisobutylenes), NBRs (acrylonitrile butadiene copolymers), polyisoprenes, methyl-butylene copolymers, isoprene isobutylene copolymers.

Production method: polymers of this type have been disclosed, for example, in Kunststoff-Handbuch (Plastics Handbook), Vol. IV. Hanse Verlag, Ullmann (4^{th} Edition), 19, page 167 et seq,
Winnacker-Kückler (4^{th} Edition), 6, 353 to 367
Elias and Vohwinkerl, Neue Polymere Werkstoffe (New Polymeric Materials), Munich, Hanser 1983,
Franck and Biederbick, Kunststoff Kompendium (Plastics Compendium) Würzburg, Vogel 1984.

According to the invention, suitable thermoplastic plastics also include thermoplastic, aromatic polycarbonates, in particular those based on diphenols with the following formula (I): 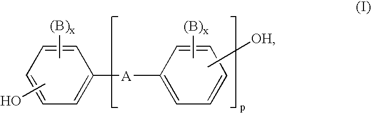
wherein:

A represents a simple bond, C₁-C₅ alkylene, C₂-C₅ alkylidene, C₅-C₆ cycloalkylidene, —S—, —SO₂—, —O—, —CO— or a C₆-C₁₂ arylene group, which if appropriate may be condensed with other aromatic rings containing heteroatoms

the B groups each independently represent a C₁-C₈ alkyl, C₆-C₁₀ aryl, particularly preferably phenyl, C₇-C₁₂ aralkyl, preferably benzyl, halogen, preferably chlorine, bromine,

x each independently represents 0, 1 or 2

p represents 1 or 0,
or alkyl-substituted dihydroxyphenyl cycloalkares with the formula (II) 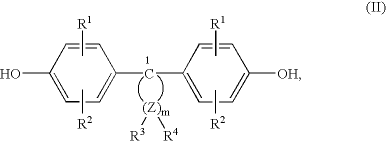
wherein:
R¹ and R² each independently represent hydrogen, halogen, preferably chlorine or bromine, C₁-C₈ alkyl, C₅-C₆ cycloalkyl, C₆-C₁₀ aryl, preferably phenyl and C₇-C₁₂ aralkyl, preferably phenyl C₁-C₄ alkyl, in particular benzyl,
m represents an integer from 4 to 7, preferably 4 or 5
R³ and R⁴ are each independently selected for each Z and represent hydrogen or C₁-C₆ alkyl preferably hydrogen, methyl, or ethyl,
and
Z represents carbon, with the proviso that on at least one Z atom, R³ and R⁴ simultaneously represent alkyl.

Suitable diphenols in formula (I) are, for example, hydroquinone, resorcinol, 4,4′-dihydroxydiphenyl, 2,2-bis(4-hydroxyphenyl)-propane, 2,4-bis(4-hydroxyphenyl)-2-methylbutane-, 1,1-bis(4-hydroxyphenyl)cyclohexane, 2,2-bis(3-chloro-4-hydroxyphenyl)propane, 2,2-bis(3,5-dibromo-4-hydroxyphenyl)propane.

Preferred diphenols in formula (I) are 2,2-bis(4-hydroxyphenyl)-propane, 2,2-bis(3,5-dichloro-4-hydroxyphenyl)propane and 1,1-bis(4-hydroxyphenyl)cyclohexane.

Preferred diphenols in formula (II) are dihydroxydiphenylcycloalkanes with 5- and 6-ring C atoms in the cycloaliphatic group [(m=4 or 5 in formula (II)], such as, for example, the diphenols corresponding to the formulae 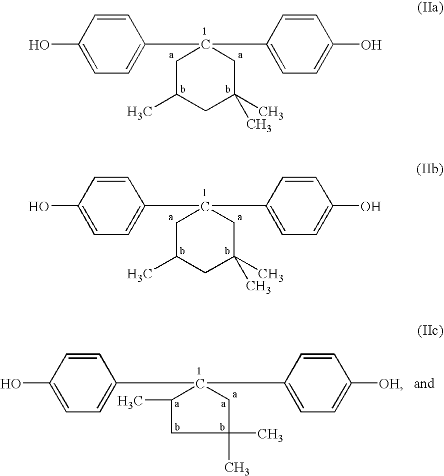
wherein the 1,1-bis(4-hydroxyphenyl)-3,3,5-trimethylcyclohexyne (formula (IIc) is particularly preferred.

The suitable polycarbonates according to the invention may be branched in a known manner and to be more precise preferably by the incorporation of 0.05 to 2.0 mol %, based on the sum of the diphenols used, of compounds which are trifunctional or more than trifunctional such as, for example, those compounds having three or more than three phenolic groups, for example:

phloroglucinol,

4,6-dimethyl-2,4,6-tri(4-hydroxyphenyl)heptene-2,

4,6-dimethyl-2,4,6-tri(4-hydroxyphenyl)heptane,

1,3,5-tri(4-hydroxyphenyl)benzene,

1,1,1-tri(4-hydroxyphenyl)ethane,

tri(4-hydroxyphenyl)phenylmethane,

2,2-bis(4,4-bis(4-hydroxyphenyl)cyclohexyl)propane,

2,4-bis(4-hydroxyphenyl)-isopropyl)phenol,

2,6-bis(2-hydroxy-5′-methylbenzyl)-4-methylphenol,

2-(4-hydroxyphenyl)-2-(2,4-dihydroxyphenyl)propane,

hexa(4-(4-hydroxyphenylisopropyl)phenyl)ortho-terephthalic ester,

tetra(4-hydroxyphenyl)methane,

tetra(4-(4-hydroxyphenylisopropyl)phenoxy)methane and

1,4-bis((4′-,4″-dihydroxytriphenyl)methyl)benzene.

Some of the other trifunctional compounds include 2,4-dihydroxybenzoic acid, trimesic acid, trimellitic acid, cyanuric chloride and 3,3-bis(3-methyl-4-hydroxyphenyl)-2-oxo-2,3-dihydroindole. In addition to bisphenol A homopolycarbonate, preferred polycarbonates are the copolycarbonates of bisphenol A with up to 15 mol %, based on the molar sum of diphenols, of 2,2-bis(3,5-dibromo-4-hydroxyphenyl)propane.

The aromatic polycarbonates to be used may be partially replaced by aromatic polyester carbonates.

Aromatic polycarbonates and/or aromatic polyester carbonates are known from literature and/or can be prepared by methods known from literature (for the production of aromatic polycarbonates, see, for example, Schnell, “Chemistry and Physics of Polycarbonates”, Interscience Publishers, 1964 and DE-AS 1 495 626, DE-OS 2 232 877, DE-OS 2 703 376, DE-OS 2 714 544, DE-OS 3 000 610, DE-OS 3 832 396; for the production of aromatic polyester carbonates, for example, DE-OS 3 077 934).

Aromatic polycarbonates and/or aromatic polyester carbonates may be produced, for example, by the reaction of diphenols with carbonyl halides, preferably phosgene, and/or with aromatic dicarboxylic dihalides, preferably benzene dicarboxylic dihalides, by the phase interface process, optionally, with the use of chain stoppers and, optionally, with the use of branching agents which are trifunctional or more than trifunctional.

Also suitable as thermoplastic plastics are styrene copolymers of one or at least two ethylenically unsaturated monomers (vinyl monomers) such as, for example, of styrene, α-methylstyrene, ring-substituted styrenes, acrylonitrile, methacrylonitrile, methyl methacrylate, maleic acid anhydride, N-substituted maleimides and (meth)acrylic acid esters with 1 to 18 C atoms in the alcohol component.

The copolymers are resinous, thermoplastic and free from rubber.

Preferred styrene copolymers are those comprising at least one monomer from the series styrene, α-methylstyrene and/or ring-substituted styrene with at least one monomer from the series acrylonitrile, methacrylonitrile, methyl methacrylate, maleic acid anhydride and/or N-substituted maleic imide.

Particularly preferable weight ratios in the thermoplastic copolymer are 60 to 95% by weight of the styrene monomer and 40 to 5% by weight of the other vinyl monomers.

Particularly preferred copolymers are those comprising styrene with acrylonitrile, and, optionally, with methyl methacrylate, of α-methylstyrene with acrylonitrile and, optionally, with methyl methacrylate, or of styrene and α-methylstyrene with acrylonitrile, and, optionally, with methyl methacrylate.

The styrene-acrylonitrile copolymers are known and may be produced by radical polymerisation, in particular by emulsion, suspension, solution or bulk polymerisation. These copolymers preferably have molecular weights \overline{M}_{W} (weight average as determined by light scattering or by sedimentation) of between 15,000 and 200,000 g/mol.

Particularly preferred copolymers also include statistically built-up copolymers of styrene and maleic acid anhydride, which may preferably be produced from the corresponding monomer, with incomplete reactions, preferably by continuous bulk or solution polymerisation.

The proportions of these two components of the statistically built-up styrene-maleic acid anhydride copolymers which are suitable according to the invention can vary within wide limits. The preferred maleic acid anhydride content is from 5 to 25% by weight. Instead of styrene, the polymers may also contain ring-substituted styrenes, such as ρ-methylstyrene, 2,4-dimethylstyrene and other substituted styrenes, such as α-methylstyrene.

The molecular weights (number average \overline{M}n) of the styrene-maleic acid anhydride copolymers can vary over a wide range. The range is preferably from 60,000 to 200,000 g/mol. A limiting viscosity of 0.3 to 0.9 (as measured in dimethylformamide at 25° C.; cf.

Hoffman, Kuhn, Polymeranalytik I, Stuttgart 1977, pages 316 et seq) is preferred for these products.

Also suitable for use as thermoplastic plastics are graft copolymers. These include graft copolymers which have rubber-like elastic properties and are substantially obtainable from at least 2 of the following monomers: chloroprene, 1,3-butadiene, isopropene, styrene, acrylonitrile, ethylene, propylene, vinyl acetate and (meth)acrylic acid esters with 1 to 18 C atoms in the alcohol component; i.e. polymers such as those as described in, for example, “Methoden der organischen Chemie” (Methods of organic chemistry) (Houben-Weyl), Vol. 14/1, Georg Thieme Verlag, Stuttgart, 1961, pp. 393-406 and in C. B. Bucknall “Toughened Plastics”, Appl. Science Publishers, London 1977. Preferred graft polymers are partially cross-linked and have gel contents of more than 20% by weight, preferably more than 40% by weight, in particular more than 60% by weight.

The preferred graft copolymers include, for example, copolymers consisting of styrene and/or acrylonitrile and/or alkyl (meth)acrylic acid alkyl esters grafted onto polybutadienes, butadiene-styrene copolymers and acrylic rubbers; i.e. copolymers such as those described in DE-OS 1 694 173 (=U.S. Pat. No. 3,564,077); polybutadienes, butadiene/styrene or 25 butadiene/acrylonitrile copolymers, polyisobutenes or polyisoprenes grafted with alkyl acrylates or alkyl methacrylates, vinyl acetate, acrylonitrile, styrene and/or alkylstyrenes such as those described, for example, in DE-OS 2 348 377 (=U.S. Pat. No. 3,919,353).

Particularly preferred polymers are, for example, ABS polymers, such as those described in 30 DE-OS 2 035 390 (=U.S. Pat. No. 3,644,574) or in DE-OS 2 248 242 (=GB-PS 1 409 275).

The graft copolymers can be prepared by known processes, such as, for example, bulk, suspension, emulsion or bulk-suspension processes.

The thermoplastic polyamides used may be polyamide 66 (polyhexamethylene adipinamide), or polyamides of cyclic lactams having 6 to 12 C (carbon) atoms, preferably of lauryl lactam and more preferably of ε-caprolactam=polyamide 6 (polycaprolactam), or copolyamides containing as chief components 6 or 66 or mixtures with the chief component of the said polyamides. Preferred is a polyamide 6 produced by activated anionic polymerisation or copolyamide produced by activated anionic polymerisation with polycaprolactam as the chief component.

b) Glass or Ceramic Materials

The ceramic materials particularly suitable for the ultraphobic surface and/or its substrate are oxides, fluorides, carbides, nitrides, selenides, tellurides, sulphides, in particular of metals, boron, silicon or germanium or mixed compounds thereof or physical mixtures of these compounds, in particular P1 oxides of zirconium, titanium, tantalum, aluminium, hafnium, silicon, indium, tin, yttrium or cerium,
fluorides of lanthanum, magnesium, calcium, lithium, yttrium, barium, lead, neodymium or aluminium in the form of cryolite (sodium aluminium fluoride, Na₃AlF₆)
carbides of silicon or tungsten,
sulphides of zinc or cadmium,
selenides and tellurides of germanium or silicon,
nitrides of boron, titanium or silicon.

In principle, glass is also suitable for the ultraphonic surface and/or its substrate. This includes all types of glass known to a person skilled in the art and described for example in the publications from H. Scholze “Glas, Natur, Struktur, Eigenschaften” (Glass, nature, structure, properties), Springer Verlag 1988 or the manual “Gestalten mit Glass” (Forming with glass), Interpane Glas Industrie AG, 5^{th} Edition 2000.

Preferably, the glass used for the substrate is an alkaline earth-alkali silicate glass based on calcium oxide, sodium oxide, silicon dioxide and aluminium oxide or a borosilicate glass based on silicon dioxide, aluminium oxide, alkaline earth metal oxides, boric oxide, sodium oxide and potassium oxide.

Particularly preferably, the substrate is an alkaline earth alkali silicate glass which is coated on its surface with an additional zirconium oxide layer with a thickness of 50 nm to 5 μm.

In particular suitable are the conventional alkaline earth alkali silicate glasses used for sheet glass and window glass applications comprising for example 15% calcium oxide, 13 to 14% sodium oxide, 70% silicon dioxide and 1 to 2% aluminium oxide. Also suitable are borosilicate glasses used, for example, as fire protection glass and comprising, for example, 70 to 80% silicon dioxide, 7 to 13% boric oxide, 2 to 7% aluminium oxide, 4 to 8% sodium and potassium oxide and 0 to 5% alkaline earth metal oxides.

c) Other Materials

Also suitable is carbon, in particular in a coating known to a person skilled in the art as a DLC (diamond-like-carbon) coating and described in the publication “Dünnschichtechnologie”, (Thin layer technology) Eds. H. Frey and G. Kienel, VDI-Verlag, Düsseldorf 1987. The DLC layer is preferably applied to a carrier material different from carbon.

In addition, metals are particularly suitable for the ultraphobic surface and/or its substrate. Particularly preferable are metals chosen from the series magnesium, mangenese, titanium, vanadium, chromium, iron, cobalt, nickel, copper, beryllium, zinc, zirconium, niobium, molybdenum, ruthenium, rhenium, osmium, palladium, silver, cadmium, indium, tin, tantalum, tungsten, iridium, platinum, gold, lead, bismuth, or a mixture or an alloy of said metals.

Particularly preferably, the substrate is provided with an additional coating of a hydrophobic or oleophobic phobing agent.

Phobing Agents:

Hydrophobic or oleophobic phobing agents are surface-active compounds of any molar mass. These compounds are preferably cationic, anionic, amphoteric or non-ionic surface-active compounds, such as those listed, for example, in the dictionary “Surfactants Europa, A Dictionary of Surface Active Agents available in Europe, Edited by Gordon L. Hollis, Royal Society of Chemistry, Cambridge, 1995.

Examples of anionic phobing agents to mention are: alkyl sulphates, ether sulphates, ether carboxylates, phosphate esters, sulphosuccinates, sulphosuccinate amides, paraffin sulphonates, olefin sulphonates, sarcosinates, isothionates, taurates and lignin compounds.

Examples of cationic phobing agents to mention are: quaternary alkyl ammonium compounds and imidazoles.

Examples of amphoteric phobic agents are betaines, glycinates, propionates and imidazoles.

Non-ionic phobing agents are, for example: alkoxyates, alkyloamides, esters, amine oxides, alkylalkoxysilanes, alkylchlorosilanes, alkylalkoxychlorosilanes, alkylthiols, and alkylpolyglycosides. Also possible are: conversion products of alkylene oxides with compounds suitable for alkylation, such as for example fatty alcohols, fatty amines, fatty acids, phenols, alkyl phenols, arylalkyl phenols such as styrene phenol condensates, carboxylic acid amides and resin acids;

Particularly preferred are phobing agents in which 1 to 100%, particularly preferably 60 to 95%, of the hydrogen atoms are substituted by fluorine atoms. Examples mentioned are perfluorinated alkyl sulphate, perfluorinated alkyl sulphonates, perfluorinated alkyl phosphates, perfluorinated alkyl phosphinates, perfluorinated alkoxysilanes, perfluorinated chlorosilanes, perfluorinated alkoxychlorosilanes, perfluorinated thiols, and perfluorinated carboxylic acids.

Preferably used as polymer phobing agents for hydrophobic coating or as polymeric hydrophobic material for the surface are compounds with a molar mass M_{W}>500 to 1,000,000, preferably 1,000 to 500,000 and particularly preferably 1500 to 20,000. These polymeric phobing agents may be non-ionic, anionic, cationic or amphoteric compounds. In addition, these polymeric phobing agents may be homopolymers, copolymers, graft polymers and graft copolymers and statistical block polymers.

Particularly preferred polymeric phobing agents are those of the type AB-, BAB- and ABC block polymers. In the AB or BAB block polymers, the A segment is a hydrophilic homopolymer or copolymer and the B block a hydrophobic homopolymer or copolymer or a salt thereof.

Particularly preferred are also anionic, polymeric phobing agents, in particular condensation products of aromatic sulphonic acids with formaldehyde and alkyl naphthaline sulphonic acids or from formaldehyde, naphthaline sulphonic acids and/or benzenesulphonic acids, condensation products from optionally substituted phenol with formaldehyde and sodium bisulphite.

Also preferred are condensation products which may be obtained by converting naphthols with alkanols, additions of alkylene oxide and at least the partial conversion of the terminal hydroxyl groups into sulpho groups or semi-esters of maleic acid and phthalic acid or succinic acid.

In another preferred embodiment of the method according to the invention, the phobing agent comes from the group of sulphosuccinates and alkylbenzenesulphonates. Also preferred are sulphated, alkoxylated fatty acids or the salts thereof. Preferably understood by alkoxylated fatty acid alcohols are in particular those C₆-C₂₂ fatty acid alcohols with 5 to 120, with 6 to 60, quite particularly preferably with 7-30 ethylene oxides, saturated or unsaturated, in particular stearyl alcohol. The sulphated alkoxylated fatty acid alcohols are preferably present as a salt, in particular as alkali or amine salts, preferably as diethylamine salt.

To produce a surface in accordance with the invention the substrate can be coated with a layer in order to obtain the claimed rms-roughness. These thin-layer techniques may generally be divided into 3 categories: coating processes from the gaseous phase, coating processes from the liquid phase and coating techniques from the solid phase.

Examples of coating processes from the gaseous phase include various vaporisation methods and glow discharge processes, such as:
cathode sputtering
vapour deposition with or without ion assistance, whereby the vaporisation source may be operated by numerous different techniques, such as: electron beam heating, ion beam heating, resistance heating, radiation heating, heat by radio frequency induction, heating by arcs with electrodes or lasers,
chemical vapour deposition (CVD)
ion plating
plasma etching of surfaces
plasma deposition
ion etching of surfaces
reactive ion etching of surfaces

Examples for coating processes from the liquid phase are:
electrochemical deposition
sol-gel coating technology
spray coating
coating by casting
coating by immersion
coating by spin-on deposition (spin coating in “spin-up” mode or “spin coating” in “spin down” mode)
coating by spreading
coating by rolling.

Examples of coating processes from the solid phase are:
combination with a prefabricated solid film, for example by lamination or bonding
powder coating methods.

A selection of different thin-layer techniques which may be used for these purposes is also given in the publication Handbook of Thin Film Deposition Processes and Techniques, Noyes Publications, 1988, which is cited here as a reference and hence is deemed to be part of the disclosure.

A person skilled in the art is also familiar with the process parameters of the selected coating process which in principle influence the roughness or the topography of the surface.

For example, for the production of thin layers on glass by deposition, the following process parameters are significant with regard to the roughness of the surface: substrate pretreatment (e.g. glowing, cleaning, laser treatment), substrate temperature, rate of evaporation, background pressure, residual gas pressure, parameters during reactive deposition (e.g. partial pressure of the components), heating/irradiation after vaporisation, ion assistance parameters during vaporisation.

A person skilled in the art knows the parameters for other coating methods, in particular those substantial for influencing the roughness, and selects them as appropriate, as explained with the example of evaporation.

In addition to varying the process parameters for the coating process, it is also possible to pre-treat or post-treat the surface or to pre-treat or post-treat the surface with different process parameters to change the roughness of the surface. This is performed for example by thermal treatment, plasma etching, ion beam irradiation, electrochemical etching, electron beam treatment, treatment with a particle beam, treatment with a laser beam or by mechanical treatment through direct contact with a tool.

A person skilled in the art is familiar with which process parameters of the selected treatment process in principle influence the roughness of the surface.

Preferably the substrate material is glass and more preferably the rms-roughness is obtained by coating the glass on its surface with an additional zirkonium oxide layer deposited by reactive electron beam evaporation.

Preferably the substrate material is glass and more preferably the rms-roughness is obtained by coating the glass on its surface with an additional zirkonium oxide layer deposited by reactive DC sputter deposition.

Preferably the substrate material is glass and more preferably the rms-roughness is obtained by coating the glass on its surface with an additional aluminium oxide layer deposited by reactive DC sputter deposition.

Preferably the substrate material is glass and more preferably the rms-roughness is obtained by coating the glass on its surface with an additional aluminium oxide layer deposited by reactive MF sputter deposition.

Preferably the substrate material is glass and more preferably the rms-roughness is obtained by coating the glass on its surface with an additional titanium oxide layer deposited by reactive MF sputter deposition.

Preferably the substrate material is glass and more preferably the rms-roughness is obtained by coating the glass on its surface with an additional tin oxide layer deposited by reactive DC sputter deposition.

Preferably the substrate material is glass and more preferably the rms-roughness is obtained by coating the glass on its surface with an additional zinc oxide layer deposited by reactive DC sputter deposition.

Preferably the substrate material is glass and more preferably the rms-roughness is obtained by coating the glass on its surface with an additional zinc oxide / aluminium oxide layer deposited by reactive DC sputter deposition.

Preferably the substrate material is glass and more preferably the rms-roughness is obtained by coating the glass on its surface with an additional zinc oxide / aluminium oxide layer deposited by RF sputter deposition.

Preferably the substrate material is glass and more preferably the rms-roughness is obtained by coating the glass on its surface with an additional silicon oxide layer deposited by RF sputter deposition.

There are numerous possible technical applications for the substrate according to the invention. Another subject of the invention is therefore also the following applications of the inventive ultraphobic and reduced light-scattering surfaces:

In the case of transparent materials, the ultraphobic surfaces may be used as screens or covering layers for transparent screens, in particular glass or plastic screens, in particular for solar cells, vehicles, aeroplanes or houses.

Another application is facade elements for buildings to protect them from moisture.

### EXAMPLES

1. ZrO₂ coatings on glass by reactive electron beam evaporation

2. ZrO₂ coatings on glass by reactive DC-sputter deposition

3. Al₂O₃ coatings on glass by reactive DC-sputter deposition

4. Al₂O₃ coatings on glass by reactive MF-sputter deposition

5. TiO₂ coatings on glass by reactive MF-sputter deposition

6. SnO₂ coatings on glass by reactive DC-sputter deposition

7. ZnO coatings on glass by reactive DC-sputter deposition

8. ZnO:Al coatings on glass by reactive DC-sputter deposition

9. ZnO/Al₂O₃ coatings on glass by RF-sputter deposition

10. SiO₂ coatings on glass by RF-sputter deposition

General Procedure

a. Cleaning of Glass Substrates

Glass substrates (refractive index 1.52) had a diameter of 57 mm and a thickness of 1.1 mm. Prior to deposition sets of 25 substrates were thoroughly cleaned by immersing and slowly moving them in a sequence of 8 automatically controlled baths containing:
1: Water (not purified), 5 min, 45° C.
2: Water (de-ionized, filtered, UV-treated)/detergent (Optical II Super, Cleaning technology SA, Switzerland, 3 vol %), 15 min, 55° C., ultrasonic treatment
3: Water (not purified), 5 min, 45° C.
4: Water (de-ionized, filtered, UV-treated)/detergent (Optical 6, Cleaning technology SA, Switzerland, 3 vol %), 15 min, 55° C., ultrasonic treatment
5: Water (not purified), 5 min, 45° C.
6: Water (de-ionized, filtered, UV-treated), 10 min, 45° C., ultrasonic treatment
7: Water (de-ionized, filtered, UV-treated), 10 min, 45° C., ultrasonic treatment
8: Water (de-ionized, filtered, UV-treated), 3 min, 45° C., slow lift-out

After slowly lifting out of bath (step 8) the substrates were dry and directly used.

b. Determination of Contact Angles and Roll-Off Angles

Water contact angles were determined from contours of 10 μl sessile drops using commercial contact angle goniometers (model OCA 20 and ACA 50, DataPhysics, Germany). The contact angles were obtained from Young-Laplace shapes that were fitted to the contours of the drops.

Contact angle goniometers were calibrated using standards of lithographic Young-Laplace contour shapes of contact angles of 120°, and 160°-175°. An error of less than 2° was obtained from the readings of these standards.

Roll-off angles were determined by tilting the sample stage of the contact angle goniometer. The roll-off angle is the critical tilt angle of a 10 μl droplet necessary to spontaneously set the droplet in motion.

The data are given as the average of the determinations at 9 different locations of each sample for both contact angles and roll-off angles.

c. Determination of Optical Scatter Losses

Determination optical scatter was performed at a wavelength given in the text according to the standard testing method ISO/DIS 13696. Details are given in A. Duparré and S. Gliech, Proc. SPIE 3141, 57-64 (1997), which is cited here as a reference and hence is part of the disclosure. The data given are the total scatter TS in forward and backward direction.

d. Coating with a Hydrophobic Top Layer

The sublayers on glass were coated with a thin hydrophobic coating of 1H,1H,2H,2H-perfluorodecyltriethoxysilane (CH₃-CH₂O)₃—Si—CH₂-CH₂—(CF₂)₇CF₃. The coating was applied as follows. The substrates were immersed in water (de-ionized, filtered, UV-treated) for 15 minutes at 45° C., then slowly lifted out and subsequently heated in an oven at 60° C. for 2 hours. Reaction with the silane vapor was performed in a sealed and evacuated vessel for 96 hours at 50° C. The silane vapor was supplied from a glass trap containing the liquid silane that was de-gassed by several freeze-thaw cycles prior to use. After the silane reaction the samples were heated at 60° C. for 2 hours in an oven. The thickness of the silane layer was approximately 12 Å as determined by X-ray photoelectron spectroscopy.

### EXAMPLES

1. ZrO₂ Coatings on Glass by Reactive Electron Beam Evaporation

The substrates were coated by reactive electron beam evaporation using Zr (purity 3N5) in a graphite liner and deposition conditions as follows: background pressure 1×10⁻⁶ mbar, oxygen partial pressure 1×10⁴ mbar, deposition rate 3.5 Å/s, substrate temperature 573 K. The thickness of the resulting ZrO₂ coating was 1 μm.

The total scatter TS was 0.18% in forward direction and 0.1% in backward direction. The contact angle for water was 153°, the roll-off angle less than 10°. The rms-roughness was (7.5±0.5) nm.

2. ZrO₂ Coatings on Glass by Reactive DC-Sputter Deposition

The substrate was coated with ZrO₂ by reactive DC sputtering using a magnetron source (St20, AJA International, USA) having a 2 inch diameter target of metallic Zr (purity 2N2). The coating conditions were as follows: 5 sccm O₂ flow, target to substrate distance 80 mm, operating power 300 W. Further conditions and results are given the table.

| | argon | thick- | contact | roll-off | rms- | total | |
|---|---|---|---|---|---|---|---|
| Ex- | flow | ness | angle | angle | roughness | scatter | haze |
| ample | sccm | nm | [degree] | [degree] | [nm] | [%] | [%] |
| 2a | 200 | 488 | 150 | <10 | 8.9 | 0.03 | 3.1 |
| 2b | 204 | 497 | 151 | <10 | 8.3 | 0.04 | 4.4 |
| 2c | 220 | 535 | 152 | <10 | 9.0 | 0.04 | 7.0 |
| 2d | 238 | 577 | 153 | <10 | 8.5 | 0.05 | 11.0 |

Comments:
total scatter in forward and backward direction at 514 nm
haze according to ASTM D1003 at 500 taber cycles

As can be seen by examples 2a-2d a contact angle of more than 140° can be achieved while the total scatter is less than 0.2%. Within these examples a roll-off angle of less than 10° is achieved. Furthermore the haze at 500 taber cycles is less than 10% for examples 2a-2c. For example 2a and 2b less than 5% is achieved.

3. Al₂O₃ Coatings on Glass by Reactive DC-Sputter Deposition

The substrate was coated with Al₂O₃ by reactive DC sputtering using a magnetron source (St20, AJA International, USA) having a 2 inch diameter target of metallic Al (purity 5N). The coating conditions were as follows: 50 sccm Ar flow, 5.5 sccm O₂ flow, target to substrate distance 80mm, operating power 300 W. Further conditions and results are given the table.

| | thick- | contact | roll-off | rms- | total | |
|---|---|---|---|---|---|---|
| ex- | ness | angle | angle | roughness | scatter | haze |
| ample | nm | [degree] | [degree] | [nm] | [%] | [%] |
| 3a | 60 | 176 | <10 | 14.3 | <1 | 0.8 |
| 3b | 67 | 176 | <10 | 13.6 | <1 | 0.6 |
| 3c | 72 | 175 | <10 | 15.5 | <1 | 0.8 |
| 3d | 138 | 177 | <10 | 14.0 | <1 | 1.0 |
| 3e | 468 | 170 | <10 | 15.6 | <1 | 2.0 |
| 3f | 185 | 178 | <10 | 12.9 | <1 | 1.0 |
| 3g | 113 | 175 | <10 | 14.5 | <1 | 0.9 |
| 3h | 62 | 177 | <10 | 14.8 | <1 | 0.9 |
| 3i | n/a | n/a | n/a | 0.5 | <1 | 1.2 |

Comments:
total scatter in forward and backward direction at 514 nm
haze according to ASTM D1003 at 500 taber cycles

As can be seen from examples 3a-3h contact angles of >>150° and roll-off angles <10° can be achieved while the total scatter remains below 1%. All samples consist of a haze less than 5%, while only sample 3e (having the largest thickness) consists of a haze that is worse than the glass substrate in example 3i.

4. Al₂O₃ Coatings on Glass by Reactive MF-Sputter Deposition

The substrate was coated with Al₂O₃ by reactive mid frequency (MF, frequency 40 kHz) sputtering using a linear twin magnetron source (Applied Films, Germany) having a target (size: 396×76×6 mm) of metallic Al (purity 5N). The coating conditions were as follows: 300 sccm Ar flow, 30 sccm O₂ flow, target to substrate distance 120 mm, operating power 4000-7000 W, coating thickness 50-500 nm, total pressure 14 mTorr.

For all samples the total scatter was less than 2%. The contact angle for water was larger than 160°, the roll-off angle less than 10°. The rms-roughness was between 12.2 nm and 18.0 nm for all samples.

5. TiO₂ Coatings on Glass by Reactive MF-Sputter Deposition

The substrate was coated with TiO₂ by reactive mid frequency (MF, frequency 40 kHz) sputtering using a twin magnetron source (2 sources on type St20, AJA International, USA) having 2 inch diameter targets of metallic Ti (purity 2N6). The coating conditions were as follows: 85 sccm Ar flow, 5-7 sccm O₂ flow, target to substrate distance 80 mm, operating power 300 W, deposited thickness 70-200 nm, deposition rate 2.3-3.5 Å/s, total pressure 1.6-1.7×10⁻³ mbar.

For all samples the total scatter was less than 3%. The contact angle for water was larger than 150°, the roll-off angle less than 10°, the rms-roughness was between 8.0 nm and 14.5 nm.

6. SnO₂ Coatings on Glass by Reactive DC-Sputter Deposition

The substrate was coated with SnO₂ by reactive DC sputtering using a magnetron source (ST20, AJA International, USA) having a 2 inch diameter target of metallic Sn (purity 3N).

The coating conditions were as follows: 70 sccm Ar flow, 8 sccm O₂ flow, target to substrate distance 80 mm, operating power 300 W, deposited thickness 180 nm.

The total scatter of the sample was less than 3%. The contact angle for water was larger than 145°, the roll-off angle less than 10°, the rms-roughness was 16.2 nm.

7. ZnO Coatings on Glass by Reactive DC-Sputter Deposition

The substrate was coated with ZnO by reactive DC sputtering using a magnetron source (ST20, AJA International, USA) having a 2 inch diameter target of metallic Zn (purity 4N5). The coating conditions were as follows: 50 sccm Ar flow, 6.5 sccm O₂ flow, target to substrate distance 80 mm, operating power 300 W, deposited thickness 200 nm.

The total scatter of the sample that was less than 3%. The contact angle for water was larger than 140°, the roll-off angle less than 10°, the rms-roughness was 4.5 nm.

8. ZnO:Al₂O₃ Coatings on Glass by Reactive DC-Sputter Deposition

The substrate was coated with ZnO/Al₂O₃ by reactive DC sputtering using a magnetron source (ST20, AJA International, USA) having a 2 inch diameter target of metallic ZnAl₂ (purity 4N). The coating conditions were as follows: 75 sccm Ar flow, 7.2 sccm O₂ flow, target to substrate distance 80 mm, operating power 300 W, deposited thickness 200 nm.

The total scatter of the sample was less than 6%. The contact angle for water was larger than 140°, the rms-roughness was 85 nm.

9. ZnO/Al₂O₃ Coatings on Glass by RF-Sputter Deposition

The substrate was coated with ZnO/Al₂O₃ by RF (frequency 13.6 MHz) sputtering using a magnetron source (ST20, AJA International, USA) having a 2 inch diameter ceramic target of ZnO/Al203 (2 wt % Al203, purity 3N5). The coating conditions were as follows: 30 sccm Ar flow, target to substrate distance 80 mn, operating power 200 W, deposited thickness 80 nm.

The total scatter of the sample was less than 5%. The contact angle for water was larger than 140°, the rms-roughness was 65 nm.

10. SiO₂ Coatings on Glass by RF Sputter Deposition

The substrate was coated with SiO₂ by RF (frequency 13.6 MHz) sputtering using a magnetron source (ST20, AJA International, USA) having a 2 inch diameter target of SiO₂ (purity 3N). The coating conditions were as follows: 30 sccm Ar flow, target to substrate distance 80 mm, operating power 180 W, deposited thickness 100 nm.

The total scatter of the sample was less than 4%. The contact angle for water was larger than 140°, the rms-roughness was 95 nm.

1. Substrate with reduced light-scattering ultraphobic surface with a total scatter loss of ≦3% and a contact angle in relation to water of at least 140° wherein the root mean square (rms-) roughness of the surface determined from an area of 1 μm×1 μm is between 1 nm and 50 nm and the substrate is a hydrophobic material, or is coated with a hydrophobic material.

2. Substrate according to claim 1, wherein the abrasion resistance of the surface determined by an increase in haze according to test method ASTM D 1003 is ≦10%, relative to an abrasion load with a Taber Abraser method according to ISO 3537 with 500 cycles, a weight of 500 g per abrading wheel and CS10F abrading wheels.

3. Substrate according to claim 1, wherein the resistance to scratching of the surface determined by an increase in haze according to test method ASTM D 1003 is ≦15% relative to a scratching load in a sand trickling test according to DIN 52348.

4. Substrate according to claim 1, wherein for a water droplet of volume 10 μl, a roll-off angle is ≦20°.

5. Substrate according to claim 1, wherein the substrate comprises plastic, glass, ceramic or carbon, optionally in transparent form.

6. Substrate according to claim 5, wherein the ceramic material is an oxide, fluoride, carbide, nitride, selenide, telluride or sulphide of a metal, or boron, silicone, germanium or mixed compounds thereof or physical mixtures of these compounds, in particular
an oxide of zirconium, titanium, tantalum, aluminium, hafnium, silicon, indium, tin, yttrium or cerium,
a fluoride of lanthanum, magnesium, calcium, lithium, yttrium, barium, lead, neodymium or cryolite (sodium aluminium fluoride, Na₃AlF₆),
a carbide of silicon or tungsten,
a sulphide of zinc or cadmium,
a selenide or telluride of germanium or silicon,
or a nitride of boron, titanium or silicon.

7. Substrate according to claim 5, wherein an alkaline earth alkali silicate glass based on calcium oxide, sodium oxide, silicon dioxide and aluminium oxide or a borosilicate glass based on silicon dioxide, aluminium oxide, alkaline earth metal oxides, boric oxide, sodium oxide and potassium oxide is used as glass.

8. Substrate according to claim 5, wherein the substrate material is coated on its surface with at least one additional layer comprising plastic, glass, ceramic or carbon, metal, optionally in transparent form.

9. Substrate according to claim 8, wherein the ceramic coating is an oxide, fluoride, carbide, nitride, selenide, telluride or sulphide of a metal, or boron, silicone, germanium or mixed compounds thereof or physical mixtures of these compounds, in particular
an oxide of zirconium, titanium, tantalum, aluminium, hafnium, silicon, indium, tin, yttrium or cerium,
a fluoride of lanthanum, magnesium, calcium, lithium, yttrium, barium, lead, neodymium or cryolite (sodium aluminium fluoride, Na₃AIF₆),
a carbide of silicon or tungsten,
a sulphide of zinc or cadmium,
a selenide or telluride of germanium or silicon,
or a nitride of boron, titanium or silicon.

10. Substrate according to claim 5, wherein a DLC layer (diamond-like carbon layer) on a carrier material different therefrom for the substrate is used as carbon, optionally in transparent form.

11. Substrate according to claim 5, wherein a thermosetting or thermoplastic plastic and/or the substrate surface is used as plastic, optionally in transparent form.

12. Substrate according to claim 11, wherein the thermosetting plastic is a diallyl phthalate resin, an epoxy resin, a urea-formaldehyde resin, a melamine-formaldehyde resin, a melamine-phenolic-formaldehyde resin, a phenolic-formaldehyde-resin, a polyimide, a silicone rubber, an unsaturated polyester resin or any possible mixture of the said polymers.

13. Substrate according to claim 11, wherein the thermoplastic plastic is a polyolefin, preferably polypropylene or polyethylene, a polycarbonate, a polyester carbonate, a polyester, preferably polybutylene-terephthalate or polyethylene-terephthalate, a polystyrene, a styrene copolymer, a styrene-acrylonitrile resin, a rubber-containing styrene graft copolymer, preferably an acrylonitrile-butadiene-styrene polymer, a polyamide, a polyurethane, a polyphenylene sulphide, a polyvinyl chloride or any possible mixture of the said polymers.

14. Substrate according to claim 1, wherein the substrate has an additional coating with a hydrophobic or oleophobic phobing agent.

15. Substrate according to claim 14, wherein that the phobing agent is a cationic, anionic, amphoteric or non-ionic surface-active compound.

16. Substrate according to claim 14, wherein an additional adhesion-promoting layer based on noble metals, preferably a gold layer with a layer thickness of from 10 to 40 nm is arranged between the phobing agent layer and the substrate.

17. Process for the preparation of a substrate with a reduced light-scattering, ultraphobic surface according to claim 1, wherein the substrate material is glass and that the rms-roughness is obtained by coating the glass on its surface with an additional zirkonium oxide layer deposited by reactive electron beam evaporation.

18. Process for the preparation of a substrate with a reduced light-scattering, ultraphobic surface according to claim 1, wherein the substrate material is glass and that the rms-roughness is obtained by coating the glass on its surface with an additional zirkonium oxide layer deposited by reactive DC sputter deposition.

19. Process for the preparation of a substrate with a reduced light-scattering, ultraphobic surface according to claim 1, wherein the substrate material is glass and that the rms-roughness is obtained by coating the glass on its surface with an additional aluminium oxide layer deposited by reactive DC sputter deposition.

20. Process for the preparation of a substrate with a reduced light-scattering, ultraphobic surface according to claim 1, wherein the substrate material is glass and that the rms-roughness is obtained by coating the glass on its surface with an additional aluminium oxide layer deposited by reactive MF sputter deposition.

21. Process for the preparation of a substrate with a reduced light-scattering, ultraphobic surface according to claim 1, wherein the substrate material is glass and that the rms-roughness is obtained by coating the glass on its surface with an additional titanium oxide layer deposited by reactive MF sputter deposition.

22. Process for the preparation of a substrate with a reduced light-scattering, ultraphobic surface according to claim 1, wherein the substrate material is glass and that the rms-roughness is obtained by coating the glass on its surface with an additional tin oxide layer deposited by reactive DC sputter deposition.

23. Process for the preparation of a substrate with a reduced light-scattering, ultraphobic surface according to claim 1, wherein the substrate material is glass and that the rms-roughness is obtained by coating the glass on its surface with an additional zinc oxide layer deposited by reactive DC sputter deposition.

24. Process for the preparation of a substrate with a reduced light-scattering, ultraphobic surface according to claim 1, wherein the substrate material is glass and that the rms-roughness is obtained by coating the glass on its surface with an additional zinc oxide/aluminium oxide layer deposited by reactive DC sputter deposition.

25. Process for the preparation of a substrate with a reduced light-scattering, ultraphobic surface according to claim 1, wherein the substrate material is glass and that the rms-roughness is obtained by coating the glass on its surface with an additional zinc oxide/aluminium oxide layer deposited by RF sputter deposition.

26. Process for the preparation of a substrate with a reduced light-scattering, ultraphobic surface according to claim 1, wherein the substrate material is glass and that the rms-roughness is obtained by coating the glass on its surface with an additional silicon oxide layer deposited by RF sputter deposition.

27. Material or building material which is a substrate according to claim 1.

28. A covering layer for transparent screens comprising the material or building material of claim 27.

29. A solar cell, vehicle, airplane or building comprising the material or building material of claim 27.
